(19) United States
(12) Patent Application Publication
(10) Pub. No.: US 2021/0286431 A1
(43) Pub. Date: Sep. 16, 2021

(54) HAPTIC INTERFACE WITH KINESTHETIC AND VIBROTACTILE STIMULATIONS

(71) Applicant: COMMISSARIAT A L'ENERGIE ATOMIQUE ET AUX ENEERGIES, Paris (FR)

(72) Inventors: Laurent ECK, (US); Sabrina PANEELS, Thiais (FR); Margarita ANASTASSOVA, Nozay (FR); Florent SOUVESTRE, Orsay (FR)

(73) Assignee: COMMISSARIAT A L'ENERGIE ATOMIQUE ET ENERGIES ALTERNATIVES, Paris (FR)

(21) Appl. No.: 16/334,581

(22) PCT Filed: Sep. 21, 2017
(86) PCT No.: PCT/FR2017/052537

§ 371 Date: Mar. 19, 2019

(30) Foreign Application Priority Data
Sep. 21, 2016 (FR) 16 58878

(51) Int. Cl. G06F 3/01; G05G 9/047

(52) U.S. Cl. CPC G06F 3/016; G06F 2203/015; G05G 2009/04766; G05G 9/047

(57) ABSTRACT

Haptic interface for the control of a system comprising:
a handle (4),
a kinesthetic stimulation device (6, 8) connected mechanically to the handle (4),
a vibrotactile stimulation device comprising three vibrating actuators (A1, A2, A3) generating a vibrotactile stimulation at the level of the handle (4) with the user, the vibrating actuators (A1, A2, A3) being such that each vibrating actuator generates vibrations in a frequency range and/or an amplitude range which are at least in part distinct from those of the other vibrating actuators,
means for measuring a position of the handle (4),
a control unit able to dispatch commands to said kinesthetic stimulation device and to the vibrotactile stimulation device at least as a function of the signals transmitted by the means for measuring the position of the handle and/or of information about the state of the system and/or its environment.

### TECHNICAL FIELD AND STATE OF THE PRIOR ART

The present invention relates to a haptic interface with improved haptic feedback.

A haptic interface can be used to control or monitor a system such as for example a construction machine or various devices in a motor vehicle, such as for example air-conditioning and a global positioning system. A haptic interface is particularly interesting when the user must keep his attention, especially his visual attention, focused on the environment for example when driving.

The haptic interface can take the form of a joystick, with two degrees of freedom. A resistive force resists the displacement of the joystick according for example to its position. By modulating the resistive force according to the position of the joystick, it is possible to define haptic patterns that will be felt by the user when displacing the joystick.

The interface may comprise one or several magnetorheological brake(s), and the resistive force may be transmitted to the joystick via a magnetorheological fluid whose apparent viscosity is modified by the application of a magnetic field to define the predefined haptic patterns.

This resistive force applied by the brake(s) is referred to as kinesthetic effect. This kinesthetic effect occurs only when the user actually displaces the joystick. Thus the user feels a haptic feedback only when he exerts an action on the joystick, but it may be interesting to be able to transmit information to the user even though the joystick is not moving, for example to inform the user about the current state of the monitored system.

It was then considered to combine with this kinesthetic effect a vibratory effect by combining with the brakes vibrations. For example, such an interface is described in document US20080024440, it comprises an electromagnetic brake which is controlled so as to also produce vibrations. But using the same actuator to generate both effects limits the richness of the vibrotactile messages. In addition, the actuator is capable of delivering only “shake” or “buzz” type messages.

In addition, it is sought to deliver stimulations the meaning of which can be understood by the largest number of users, even in the case of new or occasional users.

### STATEMENT OF THE INVENTION

It is therefore a goal of the present invention to provide a haptic interface with enhanced feel and capable of transmitting particularly significant messages understandable by the user, especially in the case of a neophyte or occasional user.

The goal of the present invention is achieved by a haptic interface comprising an element of interaction with the user, at least one brake capable of generating at least one resistive force on the element of interaction, at least one sensor detecting the position of the element of interaction with the user and at least two vibrating actuators able to generate vibrations in different frequency ranges and/or different amplitude ranges.

Thanks to the invention, on the one hand, the user may be requested while he does not exert an action on the element of interaction, in order for example to inform him about the current state of the controlled system by the interface and/or on a change in the environment of use of the controlled system and, on the other hand, the implementation of at least two different vibrating actuators involving different amplitude ranges and/or vibrational frequency ranges provides a great spectral richness that allows applying to the element of interaction significant vibratory haptic patterns for the user.

In a particularly advantageous embodiment, the control unit sends commands to the brakes and to the vibrating actuators while also taking into account the history of the already generated stimulations in order to further improve the perception of the message by the user and not to overwhelm the user with information, so that the messages remain effective.

Very advantageously, the interface implements three vibrating actuators, the first one generating low-frequencies, the second one generating medium-frequencies and the third one generating high-frequencies.

Preferably, the vibrating actuators are of rotary type having a small size. The haptic interface may preferably be at least with two degrees of freedom, and comprise two brakes each applying a resisting torque about an axis of rotation.

The subject-matter of the present invention therefore is a haptic interface for controlling a system comprising:
at least one element of interaction with a user,
at least one kinesthetic stimulation device mechanically connected to the element of interaction,
a vibrotactile stimulation device comprising n vibrating actuators able to generate a vibrotactile stimulation at the element of interaction with the user, where n being an integer greater than or equal to 2, said n vibrating actuators being such that each vibrating actuator generates vibrations in a frequency range and/or an amplitude range at least partly separate from those of the other vibrating actuators,
means for measuring a position of the element of interaction with a user,
a control unit able to send commands to said kinesthetic stimulation device and to the vibrotactile stimulation device at least according to the signals transmitted by the means for measuring the position of the element of interaction with a user and/or to information about the state of the system and/or its environment.

Preferably, the n actuators are disposed in the element of interaction with the user.

Advantageously, n is equal to 3, a first vibrating actuator generating low-frequency vibrations, a second vibrating actuator generating medium-frequency vibrations and a third vibrating actuator generating high-frequency vibrations.

Preferably, the ranges of frequencies and/or amplitudes of the vibrating actuators overlap at least partly or at least two by two.

At least one of the vibrating actuators is advantageously mounted on part of the element of interaction with the user so that the rest of the element of interaction with the user is isolated from the vibrations generated by said vibrating actuator.

For example, the element of interaction with the user is intended to be grasped by a hand of the user and in which the n actuators are distributed over the element of interaction with the user according to the distribution of the mechanoreceptors in the hand and/or the portions of the element of interaction desired to be actuated.

At least part of the n vibrating actuators may be rotary flyweight actuators.

According to an additional characteristic, the kinesthetic stimulation device comprises at least a first brake comprising a fluid whose apparent viscosity varies according to an external stimulus, for example a magnetorheological fluid, and a system for generating said stimulus on command in said fluid and an element of interaction with the fluid disposed in the fluid and mechanically connected to the element of interaction with the user. The kinesthetic stimulation device may comprise at least a second brake comprising a fluid whose apparent viscosity varies according to an external stimulus, for example a magnetorheological fluid, and a system for generating said stimulus on command in said fluid and an element of interaction with the fluid disposed in the fluid and mechanically connected to the element of interaction with the user.

For example, the mechanical connection between the element of interaction with the user and the device with kinesthetic stimulation is a cardan joint.

The means for measuring a position of the element of interaction may comprise at least one position sensor at the first brake or at the first and second brakes.

In an exemplary embodiment, the element(s) of interaction with the fluid is/are movable in rotation.

Advantageously, the haptic interface comprises means for detecting the intention of the user. The means for detecting the user's action intention are for example able to measure a torque in the first brake or in the first and second brakes.

Advantageously, the control unit is able to send commands to the kinesthetic and vibrotactile stimulation devices so that they simultaneously or successively generate kinesthetic and vibrotactile stimulations.

According to an additional characteristic, the control unit is such that, for the same message to be transmitted to the user, it generates commands to the kinesthetic stimulation device or to the vibrotactile stimulation device by taking into account the type of stimulation previously generated.

In the case of an alert message, the control unit sends a first command to the vibrotactile stimulation device to generate vibrotactile stimulation and then sends a second command to the kinesthetic stimulation device to generate kinesthetic stimulation. The control unit may repeat sending the second command until the user takes into account the alert message.

The haptic interface is for example with least two degrees of freedom.

### SHORT DESCRIPTION OF THE DRAWINGS

The present invention will be better understood based on the following description and on the appended drawings in which:

FIG. 1A is a perspective view of an exemplary embodiment of a haptic interface according to the invention, some elements being represented in transparency,

FIG. 1B is a detailed view of FIG. 1A at the cardan connection,

FIGS. 2A and 2B are detail views of FIG. 1A, the knob being transparently represented in FIG. 2B;

FIGS. 3A to 3D are schematic representations of examples of effectors that can be implemented in the haptic interface according to the invention,

FIG. 4 is a representation of the variations in frequency and amplitude according to the control voltage of a vibrating actuator with a rotary flyweight that can be implemented in the haptic interface;

FIG. 5 is a representation of the variations in frequency and amplitude according to the control voltage of three vibrating actuators with rotary flyweight that can be implemented in the haptic interface, the amplitude and frequency ranges overlapping partially,

FIG. 6 represents a flowchart of an example of a haptic interface according to the invention,

FIG. 7 is a schematic representation of the examples of messages delivered to the user by the interface by kinesthetic stimulation and vibrotactile stimulation.

### DETAILED PRESENTATION OF PARTICULAR EMBODIMENTS

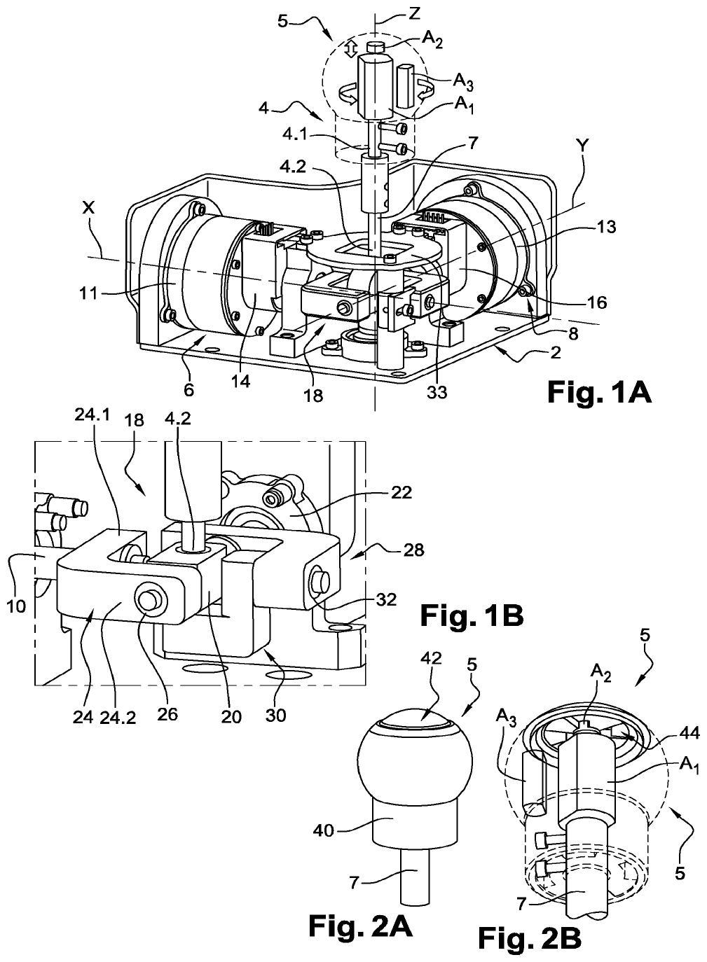

FIGS. 1A and 1B show an example of a haptic interface with two degrees of freedom according to the invention. It will be understood that this example is in no way limiting as will be described in the following description.

The haptic interface comprises a frame 2, an element of interaction 4 with a user hinged on the frame 2 and two magnetorheological brakes 6, 8, referred to as brakes in the reminder of the description.

The element of interaction 4 is in the form of a joystick and will be referred to as joystick or effector in the reminder of description.

The joystick 4 extends, in the rest position, along a longitudinal axis Z substantially perpendicular to the plane of the frame 2 and comprises a first longitudinal end 4.1 intended to be grasped by the hand of the operator and equipped for example with a knob 5 and a second longitudinal end 4.2 mechanically connected to the brakes. The knob is mounted on a rod 7 comprising the second longitudinal end 4.2.

In the represented example, the brake 6 is oriented along an axis X and the brake 8 is oriented along an axis Y orthogonal to the axis X and both are orthogonal to the axis Z. The axes X and Y define a plane parallel to the plane of the frame. The brake 6 comprises a shaft 10 (FIG. 1B) extending along the axis X and the brake 8 comprises a shaft (not visible) extending along the axis Y.

In the represented example, the two brakes 6 and 8 have similar structures, only the brake 6 will be described in detail. It will be understood that a haptic interface comprising brakes of different structures does not depart from the scope of the present invention.

An example of brake is for example in document WO2016050717. The brake 6 comprises a shaft 10 movable in rotation about the axis X and mounted in a casing 12. The shaft 10 comprises an end mechanically connected to the second end 4.2 of the joystick 4 and a second end (not visible) interacting with a magnetorheological fluid. The second end of the shaft is for example secured in rotation to a sleeve disposed in a chamber filled with magnetorheological fluid. The brake also comprises means for generating a magnetic field in the chamber so as to cause a change in the viscosity of the magnetorheological fluid. When the viscosity increases, a resisting torque is applied on the sleeve and on the shaft 10, and indeed on the joystick via the mechanical connection between the shaft 10 and the joystick 4.

The interface comprises at least one sensor for detecting the position of the joystick.

In the represented example, angular position sensors 14 and 16 measure the angular position of the brake 6, 8 shafts. It may be, for example, incremental optical encoders.

Preferably, the interface comprises at least one sensor for detecting the user's action intention measuring the force or the torque applied by the user on the joystick so as to identify his intention before a change in position of the joystick is actually detected. The sensor(s) determine(s) the direction and amplitude of the force or torque.

In the represented example, each brake 6, 8 comprises respectively a sensor 11, 13 for detecting the user's action intention. An example of such a sensor is described in document WO2016050717. It comprises for example a proof body whose deformation caused by the torque applied by the user is detected by force sensors. The proof body can be attached at one end to the frame of the interface and at another end to the magnetorheological brake, for example the casing 8. The force sensors are in contact with the proof body at its end secured to the casing of the brake.

The proof body may comprise a cylindrical-shaped body of circular section. The proof body is for example made of plastic material, such as ABS.

When a torque is applied on the shaft of the brake 6, the latter causes torsional deformation of the proof body via the casing of the brake which is interacting with the fluid which is interacting with the sleeve which is connected to the shaft. This deformation is detected by the force sensors.

The material of the proof body and its geometry can be determined according to the applied minimum torque and maximum torque, to the sensitivity of the force sensors and to the desired detection threshold. In addition, the deformation of the proof body is such that it is not perceptible by the user. For example, it can be considered that a few micron deformation of the proof body is not perceptible by the user.

Alternatively, the forces can be measured directly on the casing or on the rotary shaft, for this, a torque sensor would be implemented.

The force sensor is for example made using piezoresistive elements assembled in the form of a Wheatstone bridge, they allow a sensitivity of the order of a few tens of mV per Newton with a sufficiently high stiffness to limit the displacement to a few tens of microns at full load. Alternatively, the force sensor(s) could be replaced by one or several deformation sensor(s) formed, for example, by strain gauges directly applied to the proof body in order to detect its deformation.

The mechanical connection 18 between the joystick 4 and the shafts is a cardan system well known to the person skilled in the art, a non-limiting example of which is represented in FIGS. 1A and 1B.

In the represented example, the second end 4.2 of the joystick 4 is mounted in a part 20 by means of a sliding pivot 22. The shaft 10 is connected to the part 20 by an L-shaped part 24, a branch 24.1 of the L being secured in rotation to the shaft 10 and the other branch 24.2 of the L being hinged on the part 20 by a sliding pivot 26.

The brake 8 shaft is connected to the part 20 via two L-shaped parts 28, 30. The two L-shaped parts 28, 30 are hinged together by a sliding pivot connection 32, the L-shaped part 28 is secured in rotation to the brake 8 shaft and the L-shaped part 30 is hinged in rotation to the part 20.

The interface comprises stops to limit the displacement in the plane X and Y of the joystick, in the represented example the stops are formed by a frame 33 disposed around the joystick above the cardan joint.

Advantageously, the interface comprises feedback means in the rest position, i.e. the joystick is coaxial with the axis Z. These means are for example of the magnetic type disposed between the frame 2 and the cardan joint. It is for example two permanent magnets facing each other, aligned with the axis Z and exerting a magnetic feedback force.

The joystick can then be displaced about the two axes X and Y and the brakes 6, 8 are able to apply resisting torques about its axes according to the position of the joystick and/or to the user's action intention.

On the one hand, any other hinge between the joystick and the brakes allowing to make an interface with at least two degrees of freedom falls within the scope of the present invention, such as the one described for example in document Bin Liu. Development of 2d haptic devices working with magnetorheological fluids. Master's thesis, University of Wollongong, Australia, 2006 or in document A. Milecki, P. Bachman, and M. Chciuk. Control of a small robot by haptic joystick with magnetorheological fluid. Mechatron. Syst. Mater.—MSM, 7, 2011.

On the other hand, the brake structure could be different. Instead of a sleeve, for example a disk could interact with the magnetorheological fluid. Furthermore, the brakes could be of electrorheological type, implementing an electrorheological or electromagnetic fluid.

In addition, the brake axes may not be perpendicular. In addition, the interface could comprise more than two brakes.

Alternatively, an active brake could be considered comprising an electric motor acting on the joystick.

Furthermore, the sensor detecting the user's action intention could be disposed as close as possible to the user and for example directly on the joystick, for example in the knob.

The interface also comprises at least two and advantageously three vibrating actuators A1, A2, A3 that are mounted on the joystick, for example in the knob as seen in FIGS. 1A and 2B.

Each actuator is such that it is able to generate vibrations in a frequency range and/or an amplitude range at least partly different from those of the two other actuators. Thus the actuators cover together a broad frequency and/or amplitude spectrum, thereby offering great possibilities in terms of vibrotactile sensation.

In general, the interface may comprise several actuators generating vibrations in the same frequency range and/or the same amplitude range.

These actuators are separate from the brakes, particularly in the case of an active brake.

Preferably, three vibrating actuators are implemented. In FIGS. 1A, 2A and 2B, an example of a joystick provided with a knob comprising three vibrating actuators A1, A2, A3 can be seen. The first actuator A1 generates low-frequency vibrations, the second actuator A2 generates medium-frequency vibrations and the third actuator A3 generates high-frequency vibrations. For example, it is possible to have a first low-frequency range chosen in the 10 Hz-50 Hz band, a second medium-frequency range chosen in the 50 Hz-200 Hz band, and a third high-frequency range in the 30 Hz-400 Hz band.

In the case where the actuators would operate in two different ranges, a first frequency range in the 10 Hz-200 Hz band could be chosen with a second frequency range in the 200 Hz-500 Hz band.

The relative arrangement of the vibrating actuators is given by way of example only and is in no way limiting.

In a very advantageous manner, the actuators are attached on the effector so as to isolate them mechanically from each other, which makes it possible to isolate the stimulation they generate and to excite areas of the hand separately.

For example, the element of interaction may comprise several rigid elements each carrying one or several actuator(s), the rigid elements being mechanically connected to each other by a material or means absorbing the vibrations, such as for example foam, rubber, a flexible polymer material, a fluid, elastic means, etc. Thus, the different portions of the element of interaction are isolated from each other as regards the vibrations. For example, the element of interaction comprises a single body on which the rigid elements are mounted, the material or the means absorbing the vibrations being interposed between the body and each rigid element.

FIGS. 2A and 2B represent an example of an element of interaction providing this isolation between the actuators. In this example, the knob is in two portions and comprises a body 40 surrounding the rod of the joystick and a cup or cap 42, forming the top of the knob 5 and mechanically connected to the body 40 by flexible strips 44. The actuator A3 is attached on the body thereinside, the actuator A1 is on the rod and the actuator A2 is attached on the cup 42 thereinside. This arrangement makes it possible to isolate the vibrations generated by the actuator A2 from the rest of the knob and thus to specifically excite the palm of the hand. The haptic sensation is then improved.

The flexible strips allow mechanical isolation of the vibrations, so that if the actuator A2 is actuated, the cup vibrates but the vibrations do not propagate in the rest of the knob 40 body, because these vibrations are absorbed/damped by the flexible strips. Conversely, if the actuator A1 or A3 is actuated, the vibrations are transmitted to the knob body but not in the cup 42 because they are absorbed/damped by the flexible strips.

It will be understood that the knob may comprise three rigid elements each supporting an actuator, and more generally one rigid element per actuator, and isolated from each other so as not to transmit the vibrations generated by an actuator to the other rigid elements, in order to request the area of the hand only in contact with the rigid element(s) whose actuator(s) is/are activated.

The actuators may be disposed in any way with respect to the surface of the joystick. Preferably, they can be disposed so that the generated vibrations are in a normal plane or in a plane tangential to the surface of the skin.

Preferably the actuators are disposed on the joystick at given locations so that they can locally request the hand in given areas thereof, and match the frequency and/or amplitude ranges with the hand areas that are more particularly sensitive to these ranges. Indeed, a hand comprises different types of mechanoreceptors whose density varies according to their location on the hand. In addition, the mechanoreceptors are sensitive to different frequency and/or amplitude vibrations according to their type. For example, Pacini corpuscles are sensitive to a frequency range between 10 Hz and 1,000 Hz, with a maximum sensitivity around 200 Hz and they allow fine texture detection. There are also for example the corpuscles known as Meissner and Ruffini corpuscles sensitive to at least partly different frequencies.

Thanks to the invention, it is possible to stimulate more particularly some mechanoreceptors.

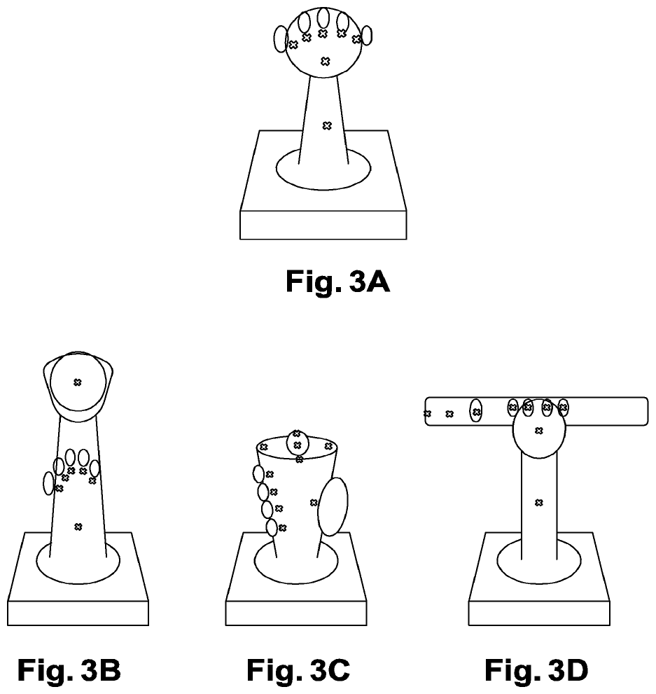

For example FIGS. 3A to 3D, show several examples of different distributions of the actuators on a joystick. The crosses represent the actuators, the small oval shapes represent the ends of the fingers and the large oval shape represents the palm of the hand.

In FIG. 3A, the joystick is shaped by a grasp with high-precision, only the ends of the fingers being in contact with the joystick.

In FIG. 3B, the joystick is shaped by a forceful full-hand grasp, the palm of the hand being in contact with the free end of the joystick, the fingers are in contact with the body of the joystick.

In FIG. 3C, the joystick is shaped by a forceful full-hand grasp, the palm of the hand and the ends of the fingers being in contact with the joystick. The palm is located on one side of the joystick and the ends of the fingers are located on the other side of the joystick.

FIG. 3D shows another example of a joystick shaped for a forceful grasp, the palm of the hand being in contact with the free end of the joystick. The joystick has the shape of a T.

Having the actuators disposed in the joystick allows for a higher bandwidth and lower implementation energies compared to an electromechanical active brake system comprising a motor that must also excite the mechanical parts of the brake and of the coupling device with the effector. In addition, it is difficult in an active brake system to cover a good spectral width as a result of the excitation of the intermediate parts, for example because of the resonance phenomena.

The vibrotactile actuators may comprise a linearly displaced mass or preferably may displace a rotating mass. The rotary actuators have a small overall size and are reduced in cost. In addition, they are controlled only by an electrical voltage whose value determines both the amplitude of the vibration and the frequency of the vibration. The implementation of small actuators allows placing them in the joystick and exciting locally different regions of the hand.

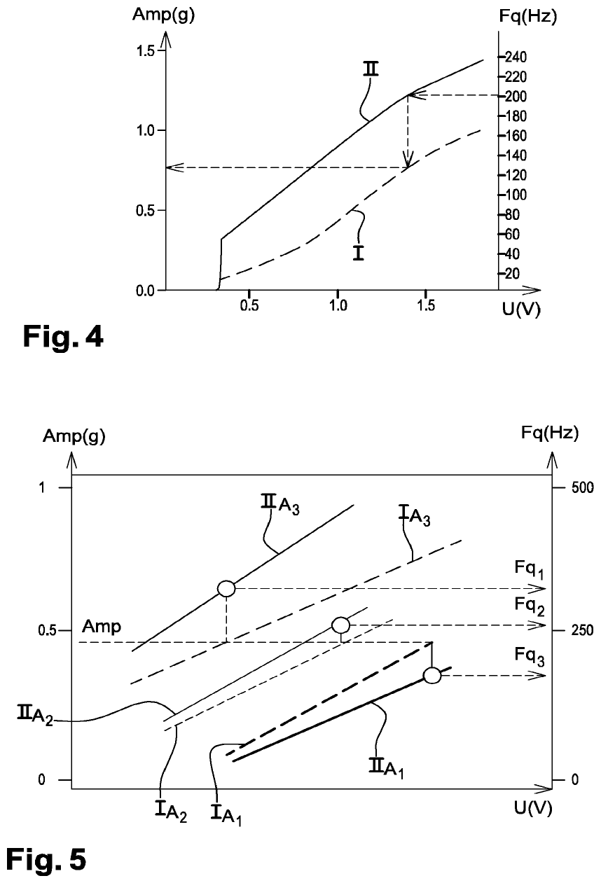

FIG. 4 graphically represents the variation in the amplitude Amp of the vibration in g and the frequency Fq in Hertz as a function of the voltage U in volt for a rotary mass actuator. The curve I represents the variation in amplitude and the curve II represents the variation in frequency as a function of the control voltage applied to the actuator. For example, if a vibration frequency of 200 Hz is desired, a voltage of the order of 1.4 V must be applied and then the vibration intensity obtained will be of the order of 0.8 g. As can be seen, there is a direct dependence between the frequency of the vibration and the amplitude of the vibration in the case of rotary flyweight actuators.

Preferably, the ranges of frequency and amplitude of the actuators overlap partially so as to have common operating areas and provide continuous operating frequency and amplitude ranges.

The need for at least part of the dependence between amplitude and vibration can be eliminated. Indeed, as shown in the graph of FIG. 5, the same amplitude Amp with different frequencies, Fq1, Fq2 or Fq3 can be obtained. The curves I_{A1}, I_{A2}, I_{A3} represent the variations in the amplitude of vibration of the actuators A1, A2, A3 respectively and the curves II_{A1}, II_{A2}, II_{A3} represent the variations in the frequency of vibrations of the actuators A1, A2, A3 respectively. The amplitude and the frequency vary according to the voltage applied, the latter is not represented on the abscissa axis.

An interface in which the ranges of frequency and/or amplitude of the vibrating actuators would be entirely separate and an interface in which the ranges of frequency and/or amplitude of some of the vibrating actuators would partially overlap do not depart from the scope of the present invention.

The vibrating actuators do not require movement of the interface to be actuated and generate vibrotactile stimulation. They can be activated to send to the user a message of the contextual alert type, this alert may depend on the elapsed time, for example a too long time has elapsed without handling the joystick, or may be factual to alert the user of the occurrence of an event. The implementation of several vibrating actuators generating vibrations at different frequencies and/or at different amplitudes, gives the possibility to provide great richness of vibrotactile stimulations. For example, the low-frequency actuator makes it possible to qualify the effects produced with the medium and high frequency actuators more commonly used in the vibrotactile interfaces. Indeed, the perceived intensity is smaller but this actuator produces more pleasant sensations, ideal for non-intrusive information messages. On the other hand, the medium and high frequency actuators have a higher perceived intensity, thereby allowing to create more intense alerts or error messages.

By combining the parameters of amplitude, duration, rhythm, and choice of the actuator, it is possible to obtain a language rich in possible haptic patterns ranging from simple vibrations to more complex patterns, and pleasant vibrations to more intense or even unpleasant vibrations. The variety of the messages depends on the application, it can comprise alerts for errors, obstacles, problems, approach and end of displacement, collision, etc. or it can comprise various information such as altitude drop, empty tank, a place of interest nearby, for example in a game or monuments as part of a sightseeing tour by car, an unattached belt, etc. The different intensities of vibration generated by the actuators make the user feel the criticality of the information to transmit. The frequency of repetition of the vibrations and the duration of the vibrations can participate in improving the comprehension of the message by the user.

For example, messages involving a danger or a serious problem will be programmed more intensively, with the actuators allowing it, so as to reproduce with vibrations an alarm or a siren and may be repeated several times to accentuate the emergency alert. While informative or optional messages or at least messages not requiring an immediate response from the user, are transcribed with the other most appropriate actuators.

The vibrating actuators can be activated simultaneously, alternately according to given sequences. The implementation of several vibrating actuators makes it possible to generate complex stimulations that are explicit for the user, i.e. understandable by the user who can associate them with signals he also knows, generally sound signals such as a siren or a purr. This is then referred to as vibratory haptic metaphors.

It is possible to reproduce complex messages especially by taking into account the spatial distribution of the actuators on the joystick. For example, it is thus possible to decide to stimulate some parts of the hand or some parts of the interface in order to transmit information about the task and situation. For example, it is possible to signal a take-off of a flying object by first transmitting vibrations at the base of the joystick to notify the start of takeoff, and then progressively transmit vibrations to the free end of the joystick of the interface to notify the progress of takeoff up until the flight stability information.

An example of operation of the interface will now be described.

The user grasps the joystick and displaces it. The position sensor(s) measure(s) the position of the joystick about the axes X and Y and/or the intention sensor(s) measure(s) the torque exerted by the user on the axes X and Y. The information is processed by a control unit that sends commands to the brakes to generate a given resistance about the axes X and Y according to predetermined kinesthetic patterns. The displacement velocity vector (direction and amplitude) of the joystick and/or the acceleration vector (direction and amplitude) can also be taken into account, these can be obtained by deriving the measurements made by the position sensor.

Electromagnetic fields are generated in the brakes causing an increase in the viscosity of the magnetorheological fluid.

Magnetorheological and electrorheological brakes have a very short response time, of the order of a few milliseconds, and a large resistive force dynamics. They can then produce a wide variety of haptic patterns.

The brakes can simulate stops, indicating for example to the user that he has reached a limit configuration is not allowed to exceed, reprogrammable notches with different spatial frequencies and different shapes, for example rectangular, sinusoidal, triangular shapes, a variable resistance . . . the haptic patterns may be such that they provide guidance of the joystick in a given direction.

As indicated above, the monitoring of the brakes is carried out on the basis of the actuation state of the joystick, i.e. of its position and/or the direction and the amplitude of the velocity vector, and/or the direction and the amplitude of the displacement acceleration vector of the joystick, of the vector of the force applied by the user on the joystick.

In addition, the brakes can be monitored by taking into account the state of the system monitored by the joystick. For example, when the system presents a serious alert: the joystick may have actuation directions presenting of significant stiffness or stop sensations, or in the case of a system handling a heavy load: the stiffness and the dynamics of actuation of the joystick can be monitored to simulate handling inertia.

Thanks to the information provided by the intention sensor, the haptic sensations provided by the brakes are improved, in particular they allow reducing the sticky feeling.

The vibrating actuators may also be activated by the control unit to generate vibrotactile stimulation simultaneously with the kinesthetic stimulation, sequentially, complementarily to or instead of the kinesthetic stimulation.

By actuating the vibrating actuator(s) simultaneously with the brake(s), a haptic redundancy effect is generated, which reinforces the message to be provided.

By operating the vibrating actuator(s) sequentially with the brake(s), it is possible to reinforce information or to specify it, for example it is possible to consider explaining the meaning of a stop generated by the brakes. If the stop corresponds to an obstacle or an end-of-travel, the vibrotactile message may be such that it tells the user to stop his movement on the joystick.

The vibrating actuator(s) can be used complementarily to the brakes. For example, vibrotactile stimulation can be generated when an intrusive feedback such as an alert or an urgent message is required and stimulation via the brakes can be generated when a discrete and continuous feedback is desired.

Kinesthetic stimulation and vibrotactile stimulation are particularly complementary. Indeed, tactile stimulation in terms of perception is persistent, so it is preferable not to stimulate the skin continuously in a vibrotactile manner. Vibrotactile stimulation is particularly effective for relatively short stimulations in contrast to kinesthetic stimulations that do not generate these same persistence effects. It is therefore possible to apply kinesthetic stimulations continuously.

By having both vibrotactile stimulation means and kinesthetic stimulation means, there are great possibilities of communication with the user and it is possible to choose the type of stimulation most suitable for the message desired to be transmitted. For example, vibrotactile stimulation is chosen instead of the kinesthetic stimulation to transmit contextual information of the environment that does not depend on the joystick movement. Conversely, kinesthetic stimulations can be used instead of the vibrotactile stimulations when the information is difficult to transmit via vibrotactile stimulation, for example when it is desired to reproduce an effect of inertia, a spring effect, etc.

Particularly advantageously, the invention allows the control unit to combine the two types of stimulation to make communication with the user as efficient as possible. The control unit adapts the type of stimulation to be applied according to the history of stimulations already applied for example to strengthen it.

For example, during a first occurrence of the information, for example the presence of a nearby obstacle, it is possible to choose to transmit the information in a vibrotactile manner, and then, upon the following occurrences, only the kinesthetic stimulation is chosen in order, on the one hand, not to overwhelm the user with vibrations and thus avoid the phenomena of tactile persistence and, on the other hand, not to hinder the user with the repetition of information with a potentially intrusive feedback. It can be considered that the intensity of kinesthetic stimulation increases until the user reacts.

With such a procedure, it is possible for example to start by drawing the attention of the user in a case where the vibrotactile stimulation is the most effective to attract attention, and then the recognition/understanding of this information is enhanced by a kinesthetic stimulation which is the most effective to send information over a long period. Thanks to the invention, the same message is transmitted by combining the vibrotactile and kinesthetic stimulations and the generation of one or the other of the stimulations is adapted according to the stimulations already generated and applied to the user.

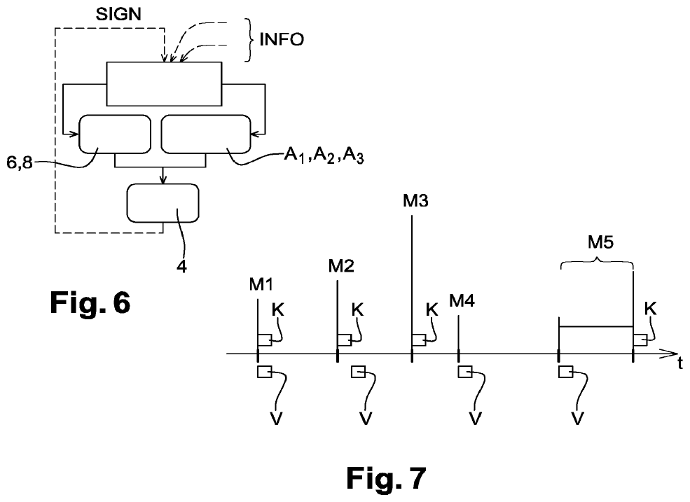

In FIG. 6, a flowchart showing the haptic interface can be seen. The references used are those already used in the description.

The control unit receives as information the signals from the sensors, referred to as SIGN, and also information about the environment and/or time information, such as the elapsed time, etc., referred to as INFO in FIG. 6.

FIG. 7 shows schematized examples of combinations of vibrotactile and kinesthetic stimulations to transmit different messages to the user. The horizontal axis is a time axis. Squares represent the type of stimulation, the square designated by K represents a kinesthetic stimulation and a square designated by V represents vibrotactile stimulation.

The message M1 to notify an end-of-travel, the achievement of a goal, etc. can be expressed by the simultaneous application of vibrotactile stimulation and kinesthetic stimulation.

The message M2 to notify an end-of-travel, an obstacle, etc. can be expressed by the application of a kinesthetic then vibrotactile stimulation.

The message M3 to notify normal/active operation, continuous speed/distance information, a physical metaphor such as a force of inertia, etc. can be expressed by the application of a kinesthetic stimulation.

The message M4 to notify an alert, such as excessive speed, a contextual point information, such as a breakpoint or an action, or a time information such as the elapsed time, etc. can be expressed by a vibrotactile stimulation. The messages M3 and M4 are complementary and express different states of the same device.

The message M5 informing of the occurrence of an event decomposes in time into a vibrotactile stimulation applied at first, informing of the first occurrence of an event and into a kinesthetic stimulation informing of a subsequent occurrence of the same event. As explained above, the use of the two different stimulations to inform of the same event, but at different times, makes it possible not to saturate the user's attention and/or overload the use of information with only vibrotactile stimulations.

It will be understood that the present invention also applies to a haptic interface with a degree of freedom and with more than two degrees of freedom, it is for example possible to provide that the joystick can move along its axis or that it can turn around its axis.

In addition, it will be understood that the haptic interface, in particular the joystick, can be adapted to be in contact with another part of the body than the hand.

Thanks to the haptic interface according to the invention, it is possible to produce new haptic patterns combining kinesthetic stimulation and vibrotactile stimulation.

The implementation of vibrating actuators having different properties makes it possible to comprise a wide range of amplitudes and frequencies of vibrations, thereby providing great spectral richness. In addition, the vibrating actuators are advantageously distributed in the effector as close as possible to the user, for example to his hand, thereby stimulating different tactile areas of the hand and reducing the energy required to generate the vibration.

In a very advantageous manner, the invention provides a complementary combination of haptic information providing messages that are particularly effective and understandable for the user.

The vibrating actuators allow, on the one hand, delivering a message while the effector is not moving and, on the other hand, generating more disruptive or violent sensations, for example in cases of alerts more difficult to achieve with the brakes.

For example, the kinesthetic information provided by the brakes can be used for continuous effects during movement and the vibrotactile information can be used to deliver programmable alert or information point messages according to the movement, position of the interface or events of the application context. The same message can be transmitted by one or several kinesthetic stimulation(s) and one or several vibrotactile stimulation(s), by taking into account previous stimulations to make the message as comprehensible as possible without saturating the user's attention.

The haptic interface also has a high compactness and moderate power consumption, in particular by using vibrating actuators separate from the kinesthetic stimulation device.

The present invention is particularly suitable for an implementation in human-machine interfaces in the field of automobiles, aeronautics, construction machines, military vehicles, etc.

It is also particularly adapted to implementation in human-machine interfaces in the field of the control of hardware systems, for example in interfaces for monitoring machine-tools, etc. and in virtual systems, such as virtual or augmented reality systems, video games, etc.

It is also particularly adapted to implementation in human-machine interfaces in the field of technical gesture training, for example in the medical and industrial fields.

1-19. (canceled)

20. A haptic interface for controlling a system comprising:
at least one element of interaction with a user,
at least one kinesthetic stimulation device mechanically connected to the element of interaction,
a vibrotactile stimulation device comprising n vibrating actuators configured to generate a vibrotactile stimulation at the element of interaction with the user, where n being an integer greater than or equal to 2, said n vibrating actuators being such that at least two vibrating actuators generate vibrations in a frequency range and/or an amplitude range at least partly separate from those of the other vibrating actuators,
at least one position sensor for measuring a position of the element of interaction with a user,
a control unit configured to send commands to said kinesthetic stimulation device and to the vibrotactile stimulation device at least according to the signals transmitted by the position sensor of the element of and/or to information about the state of the system and/or its environment, wherein the control unit is such that, for the same message to be transmitted to the user, it generates commands to the kinesthetic stimulation device or to the vibrotactile stimulation device by taking into account the type of stimulation previously generated.

21. The haptic interface according to claim 20, wherein the n actuators are disposed in the element of interaction with the user.

22. The haptic interface according to claim 20, wherein n is equal to 3, a first vibrating actuator generating low-frequency vibrations, a second vibrating actuator generating medium-frequency vibrations and a third vibrating actuator generating high-frequency vibrations.

23. The haptic interface according to claim 20, wherein the ranges of frequencies and/or amplitudes of the vibrating actuators overlap at least partly or at least two by two.

24. The haptic interface according to claim 20, wherein at least one of the vibrating actuators is mounted on part of the element of interaction with the user so that the rest of the element of interaction with the user is isolated from the vibrations generated by said vibrating actuator.

25. The haptic interface according to claim 20, wherein the element of interaction with the user is configured to be grasped by a hand of the user and wherein the n actuators are distributed over the element of interaction with the user according to the distribution of the mechanoreceptors in the hand and/or the portions of the element of interaction desired to be actuated.

26. The haptic interface according to claim 25, wherein the n actuators are distributed over the element of interaction with the user so that each actuator requests mechanoreceptors which are sensitive to its frequency and/or amplitude range.

27. The haptic interface according to claim 20, wherein at least part of the n vibrating actuators are rotary flyweight actuators.

28. The haptic interface according to claim 20, wherein the kinesthetic stimulation device comprises at least a first brake comprising a fluid whose apparent viscosity varies according to an external stimulus, and a system for generating said stimulus on command in said fluid and an element of interaction with the fluid disposed in the fluid and mechanically connected to the element of interaction with the user.

29. The haptic interface according to claim 28, wherein the kinesthetic stimulation device comprises at least a second brake comprising a fluid whose apparent viscosity varies according to an external stimulus, and a system for generating said stimulus on command in said fluid and an element of interaction with the fluid disposed in the fluid and mechanically connected to the element of interaction with the user.

30. The haptic interface according to claim 20, wherein the mechanical connection between the element of interaction with the user and the device with kinesthetic stimulation is a cardan joint.

31. The haptic interface according to claim 20, wherein the position sensor comprises at least one position sensor at the first brake or at the first and second brakes.

32. The haptic interface according to claim 20, wherein the element(s) of interaction with the fluid is/are movable in rotation.

33. The haptic interface according to claim 20, comprising an intention detector for detecting the intention of the user.

34. The haptic interface according to claim 32, wherein the element(s) of interaction with the fluid is/are movable in rotation and wherein the intention detector is configured to measure a torque in the first brake or in the first and second brakes.

35. The haptic interface according to claim 20, wherein the control unit is configured to send commands to the kinesthetic and vibrotactile stimulation devices so that they simultaneously or successively generate kinesthetic and vibrotactile stimulations.

36. The haptic interface according to claim 20, wherein, in the case of an alert message, the control unit sends a first command to the vibrotactile stimulation device to generate vibrotactile stimulation and then sends a second command to the kinesthetic stimulation device to generate kinesthetic stimulation.

37. The haptic interface according to claim 36, wherein the control unit repeats sending the second command until the user takes into account the alert message.

38. The haptic interface according to claim 20, wherein the haptic interface is with least two degrees of freedom.

39. The haptic interface according to claim 29, wherein the fluid whose apparent viscosity varies according to an external stimulus is a magnetorheological fluid.
